(19) United States
(12) Patent Application Publication
(10) Pub. No.: US 2010/0077563 A1
(43) Pub. Date: Apr. 1, 2010

(54) Side Load Carrier and Balance System for Window Sashes

(75) Inventor: Wilbur James Kellum, III, Hilton, NY (US)

Correspondence Address: BROWN & MICHAELS, PC;400 M & T BANK BUILDING, 118 NORTH TIOGA ST, ITHACA, NY, 14850, US

(73) Assignee: CALDWELL MANUFACTURING COMPANY, Rochester, NY (US)

(21) Appl. No.: 12/568,314

(22) Filed: Sep. 28, 2009

Related U.S. Application Data
(60) Provisional application No. 61/101,694, filed on Oct. 1, 2008.

(51) Int. Cl. E05F 7/00

(52) U.S. Cl. 16/193

(57) ABSTRACT

A carrier assembly consisting of a carrier, a carrier encasement and a sash latch. The carrier is secured to the end of one or more balances, including spiral rod and block and tackle balances. The weight of the sash is borne by a platform on the carrier. The undesired vertical forces exerted by the balance on the carrier is thereby translated into a force urging the carrier toward the sash until firm contact is made between the carrier encasement and the side of the sash. The translation of the torsional force into a side directed force eliminates or substantially reduces the friction that might otherwise have existed between the carrier and the jamb channel caused by the undesired vertical forces exerted by the balance on the carrier.

### REFERENCE TO RELATED APPLICATIONS

This application claims one or more inventions which were disclosed in Provisional Application No. 61/101,694, filed Oct. 1, 2008, entitled “Carrier and Balance Attachment System For Side Loading Sash Windows”. The benefit under 35 USC §119(e) of the United States provisional application is hereby claimed, and the aforementioned application is hereby incorporated herein by reference.

### FIELD OF THE INVENTION

This invention relates to the field of window sash balances. More particularly, it relates to a device for forcibly engaging the balance against the side of the sash to reduce the friction between the balance and the jamb channel generated by any friction inducing forces that are produced by the balance pulling on the carrier.

### BACKGROUND OF THE INVENTION

Balances are located in the jamb channels of window frames and are designed to assist with the raising and lowering of the sash by equalizing the gravitational forces acting upon the sash at all times. One of the problems associated with many balances, including block and tackle and spiral balances, is that they exert a force upon the carrier that results in an increase in frictional forces between the carrier and the jamb channel. For example, spiral balances are designed to equalize the weight of the window by using a torsion spring wound around a spiral rod which, in turn, is attached to a carrier to assist with the raising and lowering of the sash. As the sash is moved up or down, the spiral rod turns, as does the torsion spring. As a result of the increasing torsional forces created by the turning of the torsion spring as the rod is pulled from the carrier, combined with the fact the carrier does not necessarily correspond precisely to the size of the cross section of the jamb channel, the carrier tends to “twist” within the jamb channel, thereby creating friction between the carrier and jamb channel. This friction results in an increase in the force required to operate the window sash.

Block and tackle balances exert a different force upon the carrier, often referred to as a “lever-fulcrum” force. While different from the torsional force exerted by a spiral rod balance, a lever-fulcrum force nonetheless also causes in an increase in the frictional force between the carrier and the jamb channel.

It is therefore desirable to eliminate or substantially reduce the friction between the carrier and the jamb channel caused by the undesired forces exerted by a balance during window sash movement while not adversely affecting the easy installation and removal of the sash from the window frame.

### SUMMARY OF THE INVENTION

The present invention consists of a carrier assembly, which is allowed to traverse up and down the jamb channel with the sash. The carrier assembly contains a carrier, a carrier encasement element and a sash latch. The carrier is attached to the extendable or free end of a window balance. With spiral rod balances, one end of the carrier is attached to the free end of the spiral rod. With block and tackle balances, a hook extends from the balance to attach to the carrier. The other end of the carrier contains a substantially horizontally oriented platform having a ledge for sustaining the weight of the sash. The weight of the sash is transferred onto the platform of the carrier. A sash bracket is either permanently or non-permanently secured to the side of the sash that faces the jamb channel.

As mentioned in the background, the extension of the spiral rod of a spiral rod balance exerts an undesired torsional force on the carrier which causes the carrier to twist within the jamb channel thereby increasing friction between the carrier and the jamb channel. With a block and tackle type balance, the type of undesired force acting on the carrier is a lever-fulcrum force. The present invention eliminates or substantially reduces the frictional interaction between the carrier and the jamb channel by translating these undesired forces from the balance into a force urging the carrier into firm engagement with the side of the sash. The carrier is thus referred to hereinafter as a “side load” carrier because the undesired force is converted into a load forcibly urging the carrier against the side of the sash. The transfer of the undesired force exhibited by the balance into a side load force facilitates the vertical movement of the carrier within the jamb channel by the window operator.

A sash latch hingedly attached to the carrier secures the side load carrier to the sash bracket once the sash is installed on the window assembly. In order to install the sash in the window frame, the sash is positioned such that the sash latch is attached to the sash bracket. Conversely, when the removal of the sash is required, the sash latch is unhooked from the sash bracket and hooked into slots or holes at one of a plurality of pre-determined locations on the wall of the jamb channel to hold the carrier in place, thus allowing the sash to be removed from the window frame.

### BRIEF DESCRIPTION OF THE DRAWINGS

FIG. 1 shows an isometric side view of the various components of the carrier engaged with a sash bracket that, in turn is attached to the underside of the rail of a window sash.

FIG. 2 shows an isometric view of the carrier alone.

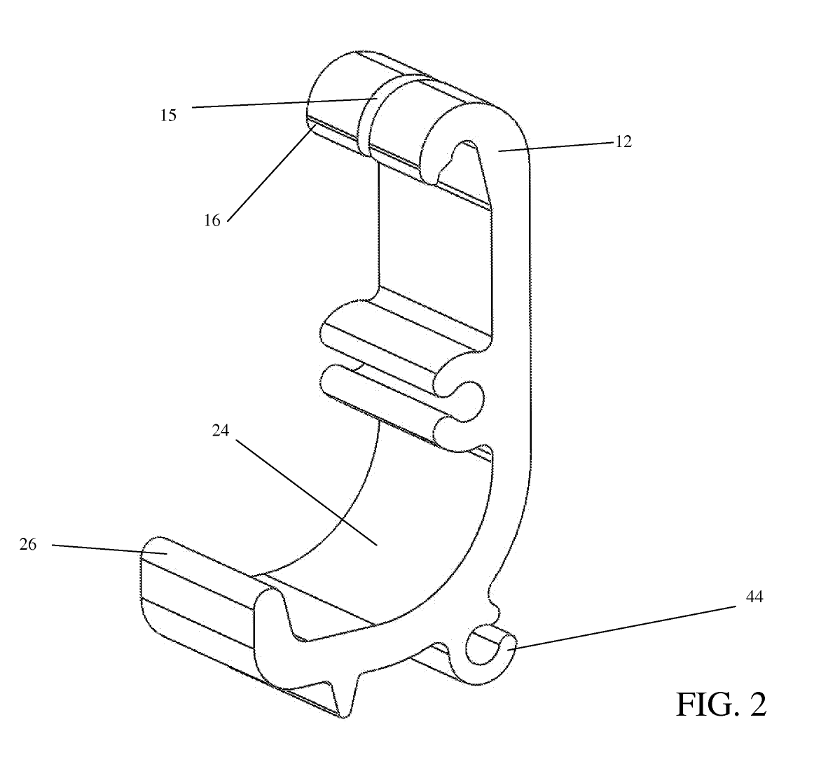

FIG. 3 shows an isometric view of the carrier and the carrier encasement member.

FIG. 4 shows an isometric view of the sash latch which secures the carrier to the sash bracket.

FIG. 5 shows an isometric view of the carrier, the carrier encasement member and the sash latch.

FIG. 6 shows a cross sectional view of the carrier engaged with a sash latch on a wooden window frame assembly.

FIG. 7 shows a cross sectional view of the sash latch disengaged from the sash bracket and secured into a wall of the jamb channel of an aluminum or fiberglass window frame assembly to permit the removal or installation of the sash.

FIG. 8 shows a cross sectional view of the embodiment of FIG. 7 where the sash latch of the carrier is secured on a ledge of the sash bracket.

### DETAILED DESCRIPTION OF THE INVENTION

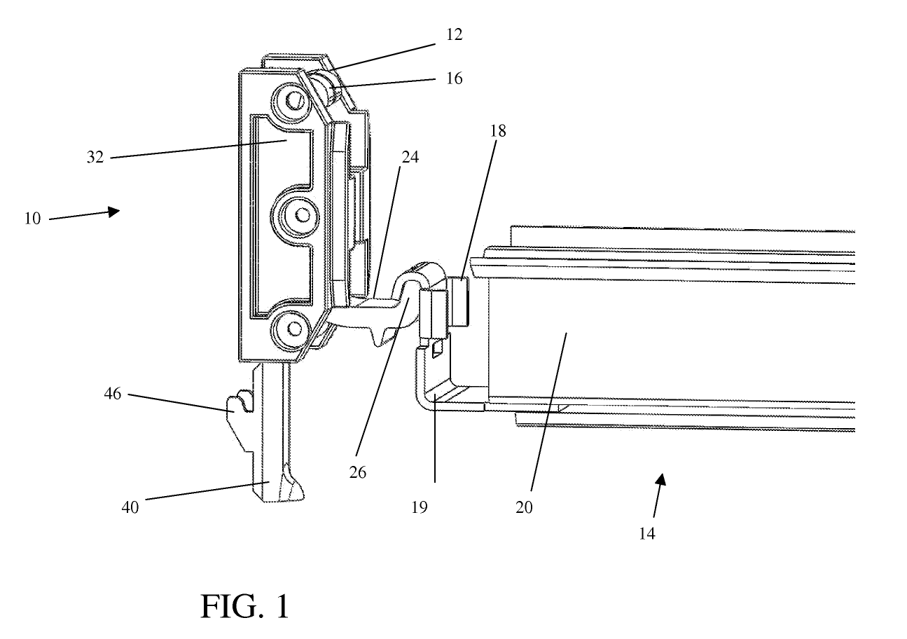

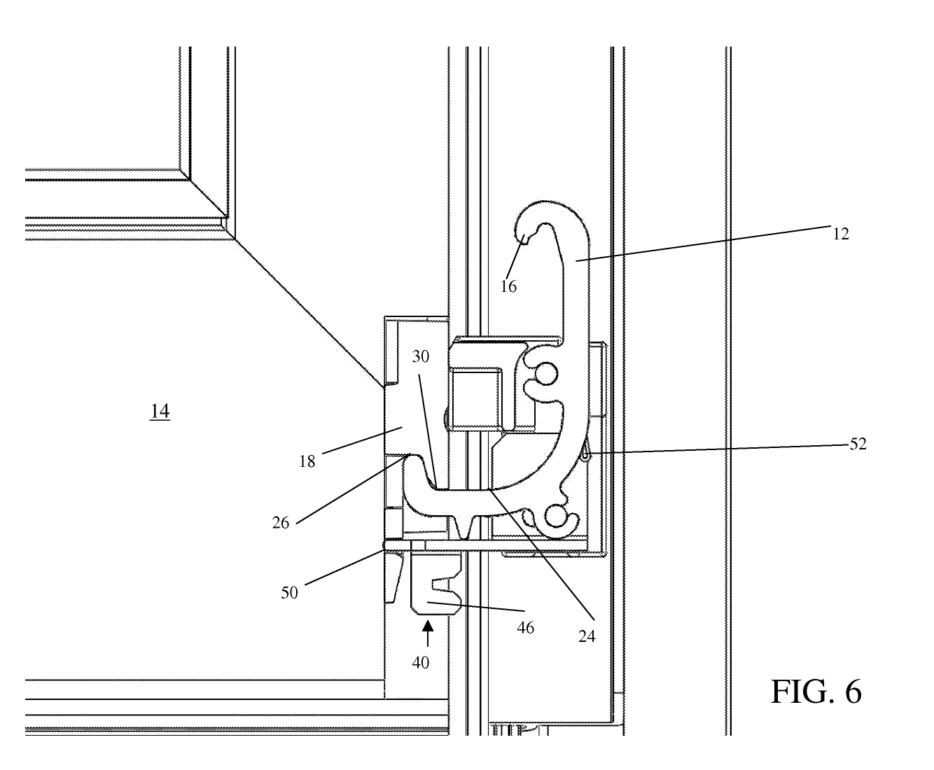

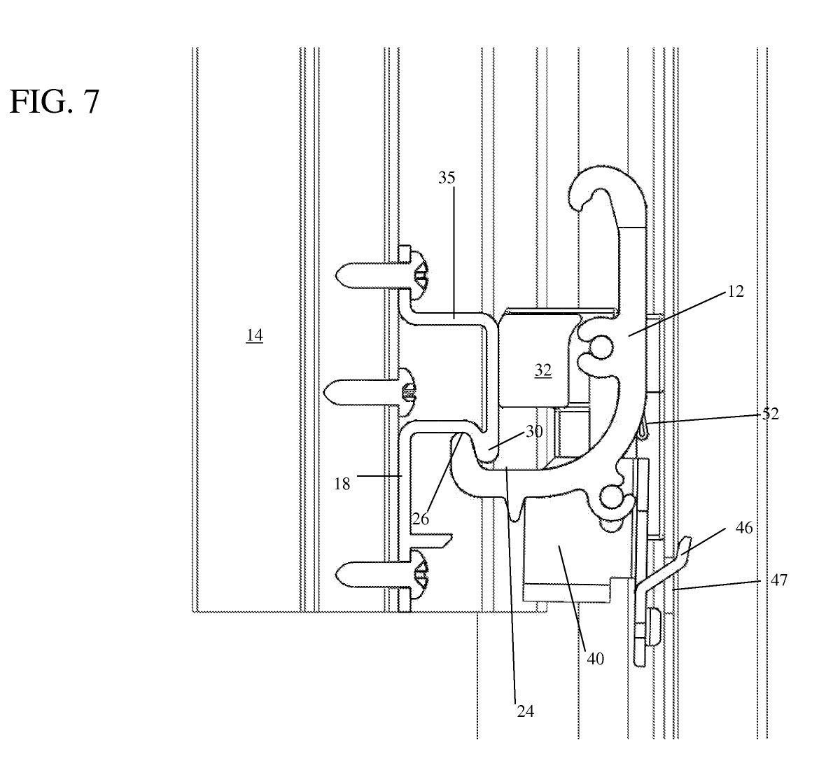

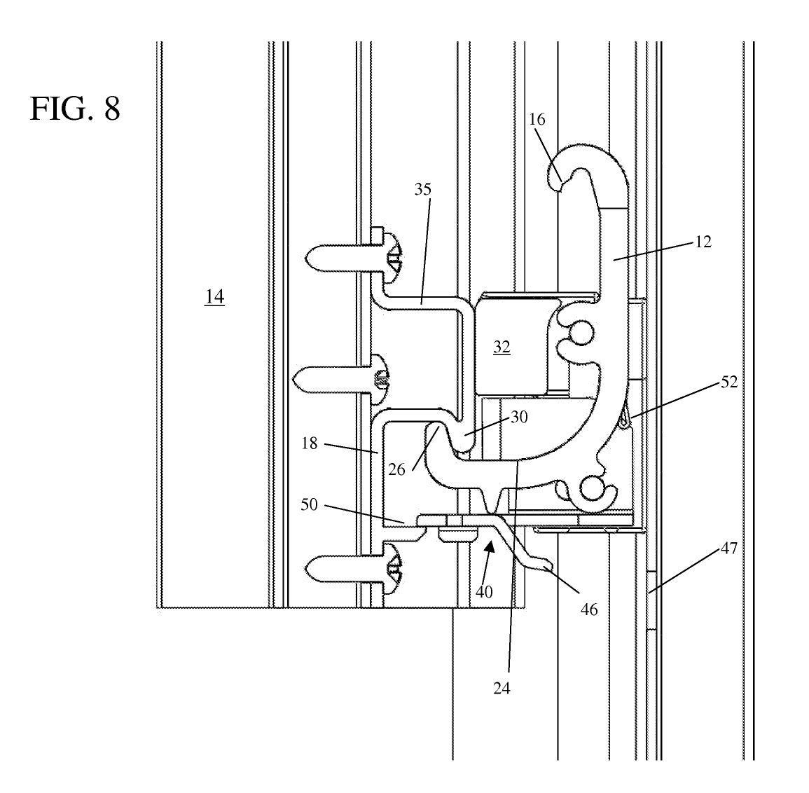

Referring to FIG. 1, the carrier assembly 10 is used in conjunction with window balances (not shown) to counteract undesired vertical forces exerted by the balances upon the carrier as the sash is moved up or down the jamb channel of the window frame assembly. Spiral rod balances exert an undesired torsional force on the carrier, causing the carrier to “twist” within the jamb channel, thus increasing the friction between the carrier and the jamb channel. Block and tackle balances exert an undesired “lever-fulcrum” force on the carrier, which also increases the friction between the carrier and the jamb channel. The carrier assembly consists of a carrier 12, a sash bracket 18 and a carrier encasement element 32. The sash bracket 18 shown in FIG. 1 is only one embodiment of this element and in this embodiment is exemplified as an “L” shaped brace 19 which is secured under a ledge located at the end of the rail 20 of the sash. The sash is generally designated herein as 14. Alternative sash brackets may be used for sashes made from different materials. For example, FIG. 6 shows a sash bracket 18 that may be used with a sash frame constructed of wood. FIGS. 7-8 show a sash bracket 18 that may be used with sash frames constructed of aluminum or fiberglass.

The carrier 12 has a hook segment 16 at its upper end. While the carrier assembly 10 may be used with any balance that generates an undesired force on the carrier, the following description focuses on spiral rod balances which exhibit a torsional force on the carrier. To install the carrier assembly 10, the end of the spiral rod 101 (see FIG. 6) of a spiral rod balance is inserted through slot 15 located within hook segment 16. A pin 102 located in proximity and secured to the end of spiral rod 101 maintains engagement between the spiral rod 101 and the carrier 12. The carrier 12 has an elongated and substantially horizontal platform 24 with an upstanding ledge 26 at its lower end to non-permanently but securely engage a corresponding sash bracket 18. The pull of the balance on the carrier is transferred into a force urging the carrier assembly 10 toward the side of the sash 14. The torsional force of the spiral rod facilitates the firm engagement of the carrier against the side of the sash.

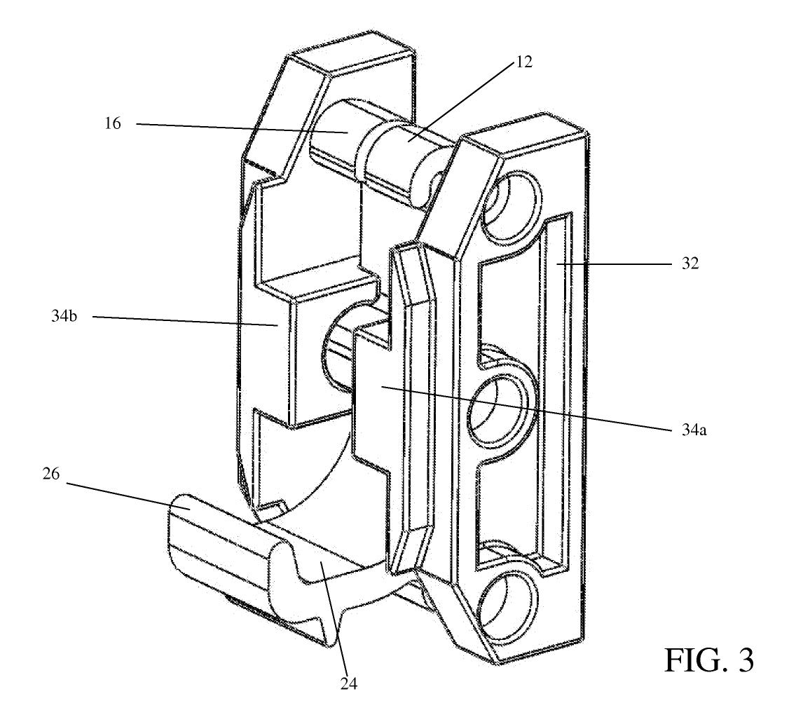

Carrier encasement member 32 contains carrier 12. The cross section of the encasement member 32 approximately corresponds to the size and dimensions of the cross-section of the jamb channel. The upward pull of the spiral rod balance on the carrier 12 urges the carrier 12 toward the side of the sash 14 until contact is made between shoulder portions 34a and 34b (FIG. 3) of the carrier encasement member 32 and the side of the sash. This embodiment shows 2 shoulder portions. However, multiple shoulder portions as well as one or more optional horizontal rib members connecting the shoulder portions may be integrally formed on the carrier encasement member 32 are within the contemplation of the invention. The carrier encasement member 32 may also contact an adapter extension 35 either affixed separately to the side of the sash stile or formed as an integral part of the sash bracket 18, as shown in FIGS. 7-8.

As the spiral rod 101 is extended further from the balance, the torsional force exhibited by the torsion spring increases. The increasing torsional force is translated into a progressively increasing force urging the side load carrier 10 into increasingly firmer engagement against the sash bracket 18 or the side of the sash. The engagement of the carrier 12 against the side of the sash 14 effectively communicates the inherent torsional force of the spiral rod balance into a force directing the carrier 12 and the carrier encasement element 26 into firm engagement with the sash 14. The transmission of the torsional force from the torsion spring through the spiral rod into a force directing the carrier toward the side of the sash effectively reduces or substantially eliminates the friction that would have otherwise developed between the jamb channel and the carrier caused by the twisting motion of the carrier.

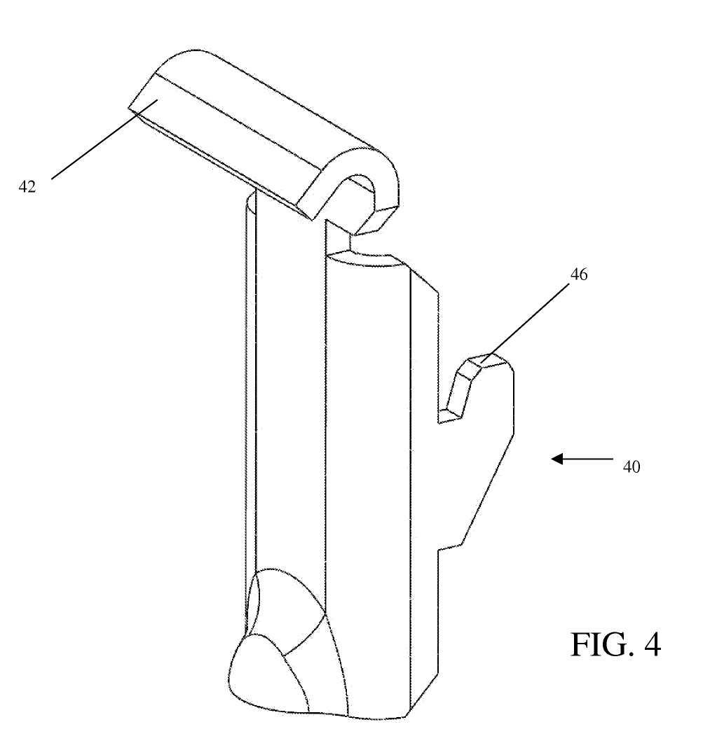

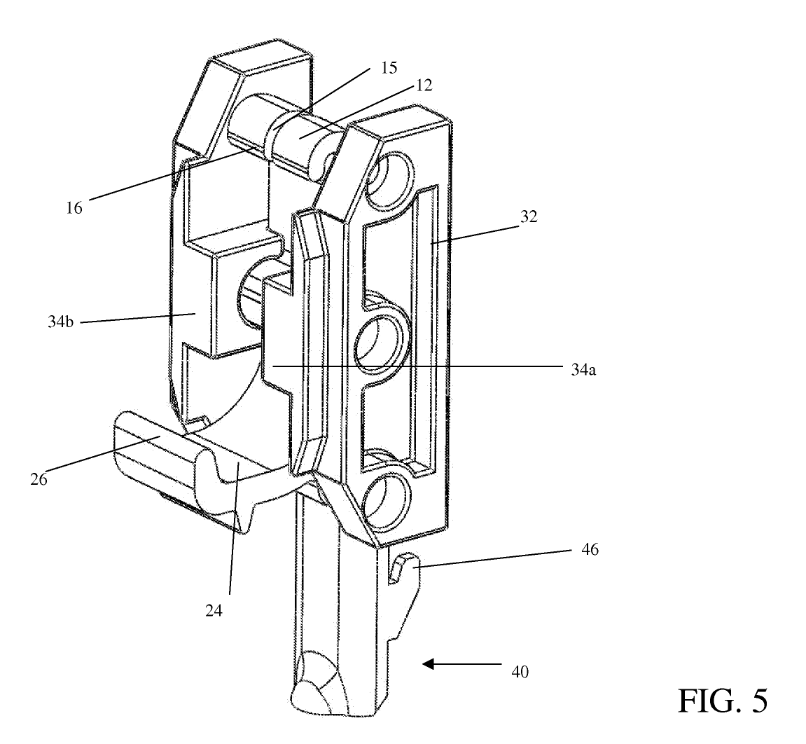

FIG. 4 shows sash latch 40. At its upper end, hook portion 42 is designed to securely and hingedly engage lower carrier hook portion 44 (See FIG. 5). As best shown in FIGS. 1 and 5-8, the sash latch 40 contains a pair of integrally formed protrusions 46 which are designed to securely fit into corresponding slots 47 located at one of a plurality of predetermined locations within the wall of the jamb channel. Upon securing the carrier assembly 10 at a specific location on the wall of the jamb channel, the sash may be readily lifted away from the horizontal platform 24 of the carrier 12 to permit removal of the sash from the window frame (see FIG. 7).

This process is simply reversed to install the sash into the window frame. The spiral rod balance is first installed within the jamb channel, traditionally, by securing the upper end of the balance to the jamb channel by a screw, rivet or other conventional means. Then, the spiral rod 101 of the balance is extended to be connected with the carrier 12. By inserting protrusions 46 of the sash latch 40 into slots 47 in the wall of the jamb channel, the carrier is non-permanently held at a pre-determined location along the jamb channel. Next, the sash is manipulated so that the sash bracket 18, already secured to the sash, is seated on the horizontal platform 24. The sash latch 40 is then pivoted away from engagement with slots 47 in the wall of the jamb channel to engage a latch engagement element 50 of sash bracket 18, as shown in FIGS. 6-8. The latch engagement element 50 may consist of a slot, as shown in FIG. 7 or it may be a ledge, as shown in FIG. 8. A spring element 52 contained on the carrier 12 assists with the engagement of the sash latch 40 to the sash bracket 18. Ramp means 54 on the sash bracket 18 urges the sash latch 40 into secure engagement with the latch engagement element 50.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A side load carrier for use with at least one sash balance, a first end of the at least one sash balance secured to a wall in a jamb channel of a window frame assembly; a second end of the at least one sash balance connected to the side load carrier; the at least one sash balance exerting an undesired force upon the side load carrier; the side load carrier comprising a carrier;
wherein the carrier converts the undesired force of the at least one balance into a force firmly urging the side load carrier against a side of a sash.

2. The side load carrier of claim 1 further comprising a carrier encasement element surrounding the carrier and a sash latch hingedly engaged with the carrier encasement element.

3. The side load carrier of claim 1 wherein the at least one sash balance is a spiral rod balance.

4. The side load carrier of claim 3 wherein the spiral rod balance exerts an undesired torsional force on the carrier.

5. The side load carrier of claim 1 wherein the at least one sash balance is a block and tackle balance.

6. The side load carrier of claim 5 wherein the block and tackle balance exerts an undesired lever-fulcrum force on the carrier.

7. The side load carrier of claim 1 further comprising a sash bracket attached to a side of the sash.

8. The side load carrier of claim 7 wherein the sash bracket is non-permanently secured to the side of the sash.

9. The side load carrier of claim 2 wherein the carrier encasement element contains a plurality of shoulder portions disposed toward the side of the sash.

10. The side load carrier of claim 1 further comprising an adapter extension, the adapter extension being either securely attached to the side of the sash or formed as an integral part of the sash bracket wherein the plurality of shoulder portions of the carrier encasement element contact the adapter extension.

11. The side load carrier of claim 2 wherein a first end of the sash latch is hingedly attached to the carrier.

12. The side load carrier of claim 11 wherein a second end of the sash latch is non-permanently secured to a latch engagement element integrally formed with the sash bracket.

13. The side load carrier of claim 1 further comprising a spring element disposed to hingedly urge the sash latch into engagement with the sash bracket.

14. The side load carrier of claim 13 wherein the sash bracket contains a ramp means to facilitate the engagement of the sash latch with the sash bracket.

15. A method for transferring an undesired force exhibited by at least one balance on a carrier into a force urging the carrier against a side of a sash; the at least one window balance having a first end for secure attachment to a wall of a jamb channel of a window frame assembly and a free end for attachment to the carrier, the method comprising the steps of:
a) attaching the free end of the at least one balance to the carrier; and
b) mounting a sash on a platform of the carrier;
wherein, the undesired force exerted on the carrier by the at least one balance is transferred to a force urging the carrier into firm engagement against the side of the sash.

16. The method of claim 15 wherein the at least one balance is a spiral rod balance.

17. The method of claim 16 wherein the spiral rod balance exerts a torsional force on the carrier.

18. The method of claim 15 wherein the at least one balance is a block and tackle balance.

19. The method of claim 18 wherein the block and tackle balance exerts a lever-fulcrum force on the carrier.

20. The method of claim 15 further comprising a sash bracket secured to the side of the sash.

21. The method of claim 15 wherein a horizontal platform on the carrier sustains the weight of the sash.

22. The method of claim 21 wherein the combination of the weight of the sash on the carrier and the undesired force exerted by the balance forcibly urges the carrier into firm engagement with the side of the sash.
